(19) United States
(12) Patent Application Publication
(10) Pub. No.: US 2017/0301944 A1
(43) Pub. Date: Oct. 19, 2017

(54) REDOX FLOW BATTERY

(71) Applicant: OCI COMPANY LTD., Seoul (KR)

(72) Inventors: Byung-Man KANG, Seongnam-si (KR); Soo-Whan KIM, Seongnam-si (KR); Min-Ki HONG, Seongnam-si (KR); Byung-Chul KIM, Seongnam-si (KR)

(21) Appl. No.: 15/508,113

(22) PCT Filed: Sep. 3, 2015
(86) PCT No.: PCT/KR2015/009304

§ 371 Date: Mar. 2, 2017

(30) Foreign Application Priority Data
Sep. 3, 2014 (KR) 10-2014-0116664

(51) Int. Cl. H01M 8/18; H01M 4/58

(52) U.S. Cl. CPC H01M 8/188; H01M 4/582; H01M 2300/0011

(57) ABSTRACT

The present invention relates to a redox flow battery and, more specifically, to a redox flow battery comprising an anolyte, a catholyte, and an ion exchange membrane, wherein the anolyte and the catholyte respectively comprise an electrolyte containing a Cl⁻ ion and an active material containing a vanadium ion, and the electrolyte comprises at least one side reaction inhibitor selected from the group consisting of a metal phosphate, a metal hydrochloride and a metal sulfate.

### TECHNICAL FIELD

The present invention relates to a redox flow battery and, more particularly, to a redox flow battery comprising an anolyte, a catholyte and an ion exchange membrane, wherein the anolyte and the catholyte each comprise an electrolyte containing a Cl⁻ ion and an active material containing a vanadium ion, and the electrolyte comprises at least one side reaction inhibitor selected from the group consisting of metal phosphates, metal hydrochlorides and metal sulfates.

### BACKGROUND ART

Conventional redox flow batteries mainly use sulfuric acid as an electrolyte. A redox flow battery using a mixed acid containing a chloride ion (for example, hydrochloric acid and sulfuric acid) as an electrolyte, as compared with a redox flow battery using sulfuric acid as an electrolyte, has the advantage of ensuring stable operation without the use of an additional heat exchanger even when using a relatively high external temperature (40° C. or higher) and a high concentration of vanadium ions (>2.5 M) (see Korean Laid-open Patent Publication No. 2013-0122626).

The operating conditions for these batteries simplify the overall system design, minimize energy loss, and reduce system cost.

However, when a catholyte is left in a high state of charge (SOC) (>80%) under a relatively high temperature condition (>40° C.) (non-discharged state), voluntarily rapid decrease in the SOC of the catholyte is observed. As a specific example, when the catholyte of 1.8 M Vⁿ⁺/4.0 M SO₄²⁻/1.8 M Cl⁻ at SOC 90% state was left at 45° C. for 14 days, the analysis of the degree of change of SOC indicates that the SOC was reduced to about 88%. Such reduction of SOC becomes larger when the concentration of Cl⁻ ion is increased to 1.8 M or more.

In addition, in the case of an catholyte of 1.8 M Vⁿ⁺/4.0 M SO₄²⁻/1.8 M Cl⁻ with SOC 100%, it was observed that the SOC was significantly reduced to about 95% under the same conditions as above. That is, when the redox flow battery is left in a fully charged state for about 2 weeks, 5% of the battery capacity is lost.

The SOC reduction with the temperature of mixed acid anolyte can be described by the following reaction scheme 1.

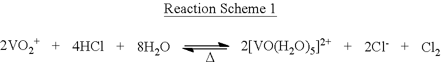

In the above reaction scheme 1, V⁵⁺ ion oxidizes Cl⁻ to generate chlorine (Cl₂), and is reversibly reduced to V⁴⁺ ion.

After completion of charging, only the V⁵⁺ ions are present in an anolyte which is in a fully charged state (SOC 100% state). Therefore, the oxidation/reduction reaction proceeds in a direction of generating V⁴⁺ ions and chlorines (Cl₂) to maintain a thermodynamic equilibrium depending on the temperature. As an external temperature (or an operating temperature of the battery) increases, the reaction rate and the amount of product in accordance with the reaction also increase proportionally. Therefore, at relatively high temperatures (>40° C.), the vanadium composition of the catholyte gradually changes to a mixture of V⁵⁺ and V⁴⁺ ions. This causes a loss of charge energy (i.e., a decrease in SOC) in the redox flow battery.

The above-described problems are particularly evident in a redox flow battery using an aqueous solution containing chloride ions as an electrolyte. Further, in the case of a redox flow battery using an aqueous solution containing chloride ions as an electrolyte, there is a question about its practicality not only because of a reduced SOC but also because of safety problems due to pressure rise and leakage in the battery cell or electrolyte container caused by the generation of chlorines (Cl₂).

### DISCLOSURE

### Technical Problem

Under these technical backgrounds, the inventors of the present disclosure have tried to develop a redox flow battery capable of suppressing the generation of chlorines (Cl₂) when an overvoltage higher than a full charge voltage is applied for the oxidation/reduction reaction of V⁵⁺ ions and Cl⁻ ions in a catholyte and the full charge of redox flow battery, even when the redox flow battery using a mixed acid containing chloride ions (for example, hydrochloric acid and sulfuric acid) as an electrolyte is left under a relatively high temperature condition.

In particular, the present inventors have found that, for a redox flow battery using an aqueous solution of sulfuric acid alone as an electrolyte, when organic compounds used for preventing precipitation of V⁵⁺ ions present in high concentration in an catholyte is applied to a redox flow battery using a mixed acid electrolyte containing chloride ions (for example, hydrochloric acid and sulfuric acid) (particularly at high temperature conditions), the oxidation/reduction reaction of V⁵⁺ ions and the organic compounds or Cl⁻ ions in the catholyte is promoted and the SOC is drastically reduced.

Accordingly, it is an object of the present disclosure to provide a redox flow battery for suppressing the oxidation/reduction reaction of V⁵⁺ ions and Cl⁻ ions in an electrolyte even when left under a high temperature condition.

Further, it is another object of the present disclosure to provide a redox flow battery capable of solving safety problems due to pressure rise and leakage in a battery cell or an electrolyte container caused by the generation of chlorines (Cl₂), as well as mitigating the reduction of the SOC in the redox flow battery with suppressed conversion of V⁺ ions and Cl⁻ ions into V⁴⁺ ions and chlorines (Cl₂) in a catholyte.

### Technical Solution

In accordance with one aspect of the present disclosure, there is provided a redox flow battery comprising an anolyte, a catholyte and an ion exchange membrane, wherein the anolyte and the catholyte each include an electrolyte containing Cl⁻ ions and an active material containing vanadium ions, and the electrolyte includes at least one side reaction inhibitor selected from the group consisting of metal phosphates (Mₓ(PO₄)_{y}), metal hydrochloride (MClₓ) and metal sulfates (Mₓ(SO₄)_{y}).

In an embodiment, the electrolyte may include an aqueous hydrochloric acid solution alone, or may include a mixture of an aqueous hydrochloric acid solution and another type of strong acid aqueous solution. In another embodiment, the electrolyte may include a mixture of an aqueous hydrochloric acid solution and an aqueous sulfuric acid solution.

In one embodiment, the metal in the side reaction inhibitor may have a standard reduction potential of V⁴⁺/V⁵⁺, preferably lower than the standard reduction potential of V³⁺/V²⁺.

In this embodiment, the metal in the side reaction inhibitor may be at least one selected from the group consisting of Cd²⁺, Fe²⁺, Cr³⁺, Al³⁺, Ce³⁺, Ti²⁺, Zn²⁺, Mg²⁺, Mg²⁺, Na⁺, Ca²⁺, Ba²⁺, K⁺ and Li⁺.

Further, the side reaction inhibitor may be at least one selected from the group consisting of ZnSO₄, K₂SO₄, MgSO₄, K₂HPO₄ and (NaPO₃)₆.

In one embodiment, the side reaction inhibitor may be included in the electrolyte in an amount of 0.1 mol. % to 50 mol. % with respect to the vanadium ions.

### Advantageous Effects

The redox flow battery according to an embodiment of the present disclosure can suppress the oxidation/reduction reaction of V⁵⁺ ions and Cl⁻ ions in an electrolyte even when the redox flow battery is left under relatively high temperature conditions by a side reaction inhibitor in the electrolyte.

That is, since the conversion of V⁵⁺ ions and Cl⁻ ions into V⁴⁺ ions and chlorines (Cl₂) in the catholyte is inhibited, the reduction of the SOC in the redox flow battery is mitigated, and the safety problems due to pressure rise and leakage in a battery cell or an electrolyte container due to the generation of chlorines (Cl₂) can also be solved.

### DESCRIPTION OF DRAWINGS

FIG. 1 is a schematic diagram of a redox flow battery according to an embodiment of the present disclosure.

FIGS. 2 to 4 show a degree of reduction of state of charge in a redox flow battery including a side reaction inhibitor (ZnSO₄).

FIG. 5 shows changes in the pressure (kPa) of catholyte in a container with respect to the duration of state of charge in a redox flow battery containing a side reaction inhibitor (ZnSO₄).

### BEST MODE

Certain terms are herein defined for convenience in order to facilitate a better understanding of the present disclosure. Unless otherwise defined herein, scientific and technical terms used in the present disclosure shall have the meanings commonly understood by one of ordinary skill in the art. In addition, unless the context clearly indicates otherwise, it should be understood that the singular form of the term includes plural forms thereof, and the plural forms of terms include singular forms thereof.

As used herein, the term “State of Charge (SOC)” can also be used with the terms “charged state” or “available remaining capacity,” and its unit is expressed in percent (%), and its amount is expressed as 0 to 100%. The state of charge indicates the present charged state of the battery, that is, a usable capacity of the battery.

The “side reaction inhibitor” introduced in a redox flow battery according to the present disclosure indicates a compound that can inhibit a side reaction that occurs when the energy stored in the redox flow battery is directly discharged and is exposed to relatively high temperature conditions, to thereby effectively prevent the reduction of the state of charge (SOC) in the redox flow battery.

Here, the side reaction may be a conversion of V⁵⁺ ions and Cl⁻ ions into V⁴⁺ ions and chlorines (Cl₂) in a catholyte according to a spontaneous oxidation/reduction reaction of V⁵⁺ ions and Cl⁻ ions occurring in the catholyte. Alternatively, the side reaction may be a reaction such as the generation of chlorines (Cl₂) produced when an overvoltage higher than a full charge voltage is applied for full charge of the redox flow battery.

One aspect of the present disclosure can provide a redox flow battery comprising an anolyte, a catholyte and an ion exchange membrane, wherein the anolyte and the catholyte each include an electrolyte containing Cl⁻ ions and an active material containing vanadium ions, and the electrolyte includes at least one side reaction inhibitor selected from the group consisting of metal phosphates (Mₓ(PO₄)_{y}), metal hydrochloride (MClₓ) and metal sulfates (Mₓ(SO₄)_{y}).

The active material in the redox flow battery includes vanadium ions as an active material, and obtains an electric energy by an oxidation/reduction reaction in the anodic and catholytes. The anodic and catholytes may include an active material and ions dissociated from the electrolyte.

At the time of charging/discharging, an oxidation/reduction reaction according to the following reaction scheme 2 occurs in the anolyte, and an oxidation/reduction reaction according to the following reaction scheme 3 occurs in the catholyte.

V³⁺+e⁻ [symbol] V²⁺,E⁰=−0.25 V Reaction scheme 2

VO₂⁺+2H⁺+e⁻ [symbol] VO²⁺+H₂O,E⁰=1.00 V Reaction scheme 3

The anolyte and the catholyte are each housed in a separate container and connected to the electrodes of a cell separated by an ion exchange membrane so that the anolyte and the catholyte can be circulated to form a redox flow battery. The container containing the anolyte and the catholyte are connected to an anode and a cathode, respectively, so that the catholyte and the anolyte are in fluid communication with the cell. At this time, the redox flow battery may include a pump for circulating the catholyte or a pump for circulating the anolyte.

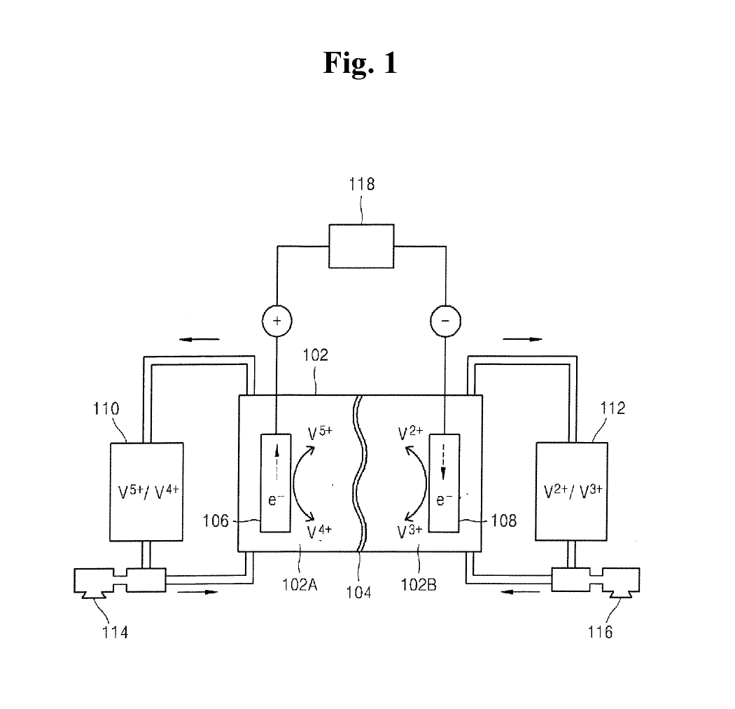

More specifically, the redox flow battery of the present disclosure will be described with reference to FIG. 1.

The catholyte storage tank 110 stores the catholyte (cathodic electrolyte), and the anolyte storage tank 112 stores the anolyte (anodic electrolyte). The anolyte may include a V²⁺ ion or a V³⁺ ion as an anodic ion, and the catholyte may include a V⁴⁺ ion or a V⁵⁺ ion as a cathodic ion.

The cathodic and anolytes stored in the catholyte storage tank 110 and the anolyte storage tank 112 are introduced into the cathode cell 102A and the anode cell 102B of the cell 102 via pumps 114 and 116, respectively. In the cathode cell 102A, electrons move through the electrode 106 depending on the operation of power source/load 118, thereby causing an oxidation/reduction reaction of V⁵⁺ [symbol] V⁴⁺.

Similarly, in the anode cell 102B, electrons move through the electrode 108 depending on the operation of power source/load 118, thereby causing an oxidation/reduction reaction of V+ [symbol] V³⁺.

After the oxidation/reduction reaction, the catholyte and the anolyte are circulated to the catholyte storage tank 110 and the anolyte storage tank 112, respectively.

Meanwhile, the cathode cell 102A and the anode cell 102B are separated by the ion exchange membrane 104 through which ions can pass. Accordingly, ion movement, i.e., crossover, may occur between the cathode cell 102A and the anode cell 102B. That is, during the charging/discharging process of the redox flow battery, the catholyte ions V⁵⁺ and V⁴⁺ of the cathode cell 102A move to the anode cell 102B and the anolyte ions V²⁺ and V³⁺ of the anode cell 102B move to the cathode cell 102A.

The redox flow battery may use an aqueous solution of hydrochloric acid as an electrolyte, whereby the anolyte and the catholyte may contain chloride ions.

When the aqueous solution of hydrochloric acid is present in the anolyte and the catholyte, a neutral vanadium pentavalent compound (VO₂Cl) is produced through the complexation of VO²⁺ and Cl⁻ ions resulting from the hydrochloric acid. Since the vanadium pentavalent compound (VO₂Cl) does not easily form a precipitate (V₂O₅) even at a relatively high temperature, for example, at about 40 to 60° C., the redox flow battery in the case of using an aqueous hydrochloric acid solution as an electrolyte can be operated stably without deteriorating the battery efficiency without using an additional heat exchanger even under the conditions of high concentration of vanadium (for example, 2.5 M or more).

Thus, the operating conditions of the redox flow battery, which uses hydrochloric acid as the electrolyte, i.e., an electrolyte containing chloride ions, simplifies the overall system design and minimizes energy loss, thereby reducing system cost.

In one embodiment, the electrolyte may include an aqueous hydrochloric acid solution alone. In other words, each of the anolyte and the catholyte may contain only Cl⁻ ion as an anion. In this case, an aqueous hydrochloric acid solution may be used as the electrolyte, and vanadium chlorides (e.g., VCl₂, VCl₃, VOCl₂, VO₂Cl, etc.) may be used as the active material.

In another embodiment, the electrolyte may include a mixture of an aqueous hydrochloric acid solution and another type of strong acid aqueous solution. In other words, each of the anolyte and the catholyte may further include other anions (a conjugate base of another kind of strong acids) as well as Cl⁻ ions.

At this time, other anions to be added may be derived from another strong acid aqueous solution (for example, sulfuric acid, nitric acid, etc.) except for an aqueous hydrochloric acid solution. Preferably, a mixture of an aqueous hydrochloric acid solution and an aqueous sulfuric acid solution may be used as the electrolyte and vanadium sulfates may be used as the active material.

When the state of charge (% unit) of the redox flow battery is driven from 0% to 100%, the charge/discharge capacity of the redox flow battery can be maximized. However, when the SOC of the redox flow battery in which Cl⁻ ions are present in the anolyte and the catholyte exceeds about 90% (i.e., at the end of full-charge of the redox flow battery), the vanadium composition of the catholyte gradually changes to a mixture of V⁵⁺ ions and V⁴⁺ ions and chlorines (Cl₂) may be generated through the oxidation/reduction reaction of V⁵⁺ ions and Cl⁻ ions (see reaction scheme 1).

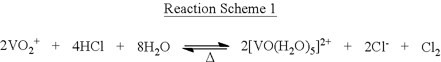

At the end of the full charge of the redox flow battery, since the tendency of Cl⁻ ions to be oxidized to chlorines (Cl₂) electrochemically resembles the tendency of V⁴⁺ ions to be oxidized to V⁵⁺ ions in the catholyte, the possibility that chlorines (Cl₂) are generated while the redox flow battery is charged increases.

On the other hand, for a redox flow battery in which the anolyte and the catholyte contain Cl⁻ ions, when the continuous charging state continues without discharging, chlorines (Cl₂) can be generated as V⁵⁺ ions in the catholyte act as an oxidizing agent to oxidize Cl⁻ ions. In particular, the amount of chlorines (Cl₂) generated by the V⁵⁺ ions may increase sharply in proportion to the temperature rise at an external high temperature, for example, at 40° C. or more.

In addition, when an overvoltage higher than the full charge voltage, for example, a voltage of 1.25 V or more and 1.85 V or less is applied for the full charge of the redox flow battery in which Cl⁻ ions exist in the anolyte and the catholyte, chlorines (Cl₂) may be generated from the anolyte and/or the catholyte.

When the chlorines (Cl₂) are generated, since the pressure in the battery cell, particularly the cathode cell, rises and accordingly safety problems such as container breakage and leakage may occur, in order to remove these problems, the electrolyte may further include at least one side reaction inhibitor selected from the group consisting of metal phosphates (Mₓ(PO₄)_{y}), metal hydrochlorides (MClₓ) and metal sulfates (Mₓ(SO₄)_{y}).

As described above, the side reaction inhibitor suppresses a spontaneous oxidation/reduction reaction of V⁵⁺ ions and Cl⁻ ions in the catholyte so as to inhibit the conversion of V⁵⁺ ions and Cl⁻ ions into V⁴⁺ ions and chlorines (Cl₂) in the catholyte, and the generation of chlorines (Cl₂) from the anolyte and/or the catholyte can be suppressed or alleviated if an overvoltage higher than the full charge voltage is applied for full charging of the redox flow battery.

In the above description, although it is mainly described in terms of the amount of chlorines (Cl₂) generated, it should be understood that the amount of chlorines (Cl₂) generated is accompanied by the conversion of V⁵⁺ ions to V⁴⁺ ions.

That is, in the catholyte containing V⁵⁺ ions and Cl⁻ ions, in order to maintain the thermodynamic equilibrium state according to the temperature, the oxidation/reduction reaction proceeds in the direction of generating V⁴⁺ ions and chlorines (Cl₂), and eventually the vanadium composition of the catholyte gradually changes to a mixture of V⁵⁺ ions and V⁴⁺ ions. This causes a loss of charge energy (i.e., a decrease in SOC) of the redox flow battery.

Therefore, even when the redox flow battery using a mixed acid containing chloride ions (for example, hydrochloric acid and sulfuric acid) as an electrolyte is left under a relatively high temperature condition, the catholyte of the redox flow battery according to the present disclosure further include a side reaction inhibitor for suppressing the oxidation/reduction reaction of V⁵⁺ ions and Cl⁻ ions in the catholyte and the generation of chlorines (Cl₂) from the anolyte and/or the catholyte by overvoltage.

The side reaction inhibitor has no effect on the normal charging and discharging of the redox flow battery, and therefore only a reduction in the SOC can be effectively suppressed.

In one embodiment, the metal in the side reaction inhibitor may have a standard reduction potential that is lower than the standard reduction potential of V⁴⁺/V⁵⁺ (E⁰=1.00 V). More preferably, the metal in the side reaction inhibitor may have a standard reduction potential lower than the standard reduction potential of V³⁺/V²⁺ (E⁰−−0.25 V).

Here, when the standard reduction potential of the metal in the side reaction inhibitor is greater than the standard reduction potential of V⁴⁺/V⁵⁺ (E⁰=1.00 V) (when included in the catholyte) and the standard reduction potential of V³⁺/V²⁺(E⁰=−0.25 V) (when included in the anolyte), the side reaction inhibitor does not inhibit side reactions in the anolyte and/or the catholyte, but it can affect the normal charging and discharging of the redox flow battery, such as, inhibiting the oxidation reaction of, for example V⁴⁺, which may cause accordingly a decrease in SOC, at the time of applying an overvoltage higher than the full charge voltage for full charging of the redox flow battery.

Accordingly, examples of the metal in the side reaction inhibitor for effectively suppressing side reactions in the anolyte and/or the catholyte without affecting the normal charging and discharging of the redox flow battery include, but are not limited to, Cd²⁺, Fe²⁺, Cr³⁺, Al³⁺, Ce³⁺, Ti²⁺, Zn²⁺, Mn²⁺, Mg²⁺, Na⁺, Ca²⁺, Ba²⁺, K⁺ and Li⁺.

That is, the side reaction inhibitor may be metal phosphates (Mₓ(PO₄)_{y}), metal hydrochlorides (MClₓ) and metal sulfates (Mₓ(SO₄)_{y}), which include as a counter cation at least one metal cation selected from the group consisting of Cd²⁺, Fe²⁺, Cr³⁺, Al³⁺, Ce³⁺, Ti²⁺, Zn²⁺, Mn²⁺, Mg²⁺, Na⁺, Ca²⁺, Ba²⁺, K⁺ and Li⁺. Examples of the side reaction inhibitor may include, but are not limited to, ZnSO₄, K₂SO₄, MgSO₄, K₂HPO₄ and (NaPO₃)₆.

The side reaction inhibitor may contain only a single compound and may also be any mixture of a plurality of compounds selected from the group consisting of metal phosphates (Mₓ(PO₄)_{y}), metal hydrochlorides (MClₓ) and metal sulfates (Mₓ(SO₄)_{y}), which include as a counter cation at least one metal cation selected from the group consisting of Cd²⁺, Fe²⁺, Cr²⁺, Al²⁺, Ce²⁺, Ti²⁺, Zn²⁺, Mn²⁺, Mg²⁺, Na⁺, Ca²⁺, Ba²⁺, K⁺ and Li⁺.

In one embodiment, the side reaction inhibitor may be included in the electrolyte in an amount of 0.1 mol. % to 50 mol. % based on the vanadium cations.

If the side reaction inhibitor is contained in an amount of less than 0.1 mol. % based on the vanadium cations, the oxidation/reduction reaction of V⁵⁺ ions and Cl⁻ ions depending on the side reaction inhibitor, and the generation of chlorines (Cl₂) from the anolyte and/or the catholyte by overvoltage may be insufficiently suppressed. On the contrary, if the side reaction inhibitor is contained in the electrolyte in an amount of more than 50 mol. % based on the vanadium cations, the side reaction inhibitor may not completely dissolved in the electrolyte but precipitate out, and therefore normal cell driving is impossible.

Since the redox flow battery suppresses the oxidation/reduction reaction of V⁵⁺ ions and Cl⁻ ions and the generation of chlorines (Cl₂) from the anolyte and/or the catholyte due to overvoltage by the side reaction inhibitor, the battery can be stably operated even if an overvoltage of about 1.25 V or more is applied to the electrolyte for full charging. The overvoltage may be between about 1.25 V and about 1.85 V, both inclusive.

The reduction of the state of charge of the side reaction inhibitor and the inhibition of the generation of chlorines (Cl₂) do not inhibit the charging/discharging efficiency of the battery, but only contribute to the oxidation/reduction reaction of V⁵⁺ ions and Cl⁻ ions in the catholyte and the generation of chlorines (Cl₂) from the anolyte and/or the catholyte. Accordingly, it is possible to suppress the increase of the gas pressure in the battery cell due to the reduction of the state of charge caused by the generation of V⁴⁺ ions and the generation of chlorines (Cl₂).

More specifically, in a redox flow battery including 0.5 M or more vanadium cations as an active material and having a concentration ratio of SO₄²⁻ and Cl⁻ ions of 1:3 to 3:1 in the electrolyte and a state of charge (SOC) of 100%, when the redox flow battery comprises the above-described side reaction inhibitor, the change in the state of charge (SOC) after being left at 45° C. for 14 days may be 4% or less, preferably 3% or less, and more preferably 2% or less.

In another embodiment, a redox flow battery including a 0.5 M or more vanadium cations as an active material and having a concentration ratio of SO₄²⁻ and Cl⁻ ions of 1:3 to 3:1 in the electrolyte and a state of charge (SOC) of 95%, when the redox flow battery comprise the above-described side reaction inhibitor, the change in the state of charge (SOC) after being left at 45° C. for 14 days may be 3% or less, preferably 2% or less, and more preferably 1% or less.

In a further embodiment, a redox flow battery including a 0.5 M or more vanadium cations as an active material and having a concentration ratio of SO₄²⁻ and Cl⁻ ions of 1:3 to 3:1 in the electrolyte and a state of charge (SOC) of 90%, when the redox flow battery comprise the above-described side reaction inhibitor, the change in the state of charge (SOC) after being left at 45° C. for 14 days may be 2% or less, preferably 1% or less, and more preferably 0.5% or less.

Hereinafter, specific examples of the present disclosure will be described. It is to be understood, however, that these examples described below are only for illustrative or descriptive purposes of the present disclosure, and thus the present disclosure should not be limited thereby.

### Experimental Example 1. Selection of Side Reaction Inhibitor

A 100 mL measuring cylinder was charged with 45 mL of a vanadium aqueous solution (1.8 M VOSO₄, 2.2 M H₂SO₄, 1.8 M HCl, and 5 mol. % or 10 mol. % metal salt or ammonium salt) and connected to a cathode of a small single cell battery having an electrode area of 25 cm² with a cation exchange membrane (DUPONT, N115) with a VITON tube.

In addition, in order to obtain a fully charged (SOC 100%) cathodic electrolyte, a 100 mL measuring cylinder of the cathode was charged with 80 mL of a vanadium aqueous solution (1.8 M VOSO₄, 2.2 M H₂SO₄, 1.8 M HCl, and 5 mol. % or 10 mol. % inhibitor of metal salt or ammonium salt) and connected to the cathode of the battery with a VITON tube.

The battery was charged at room temperature under 1.7 V cut-off condition using an ARBIN battery charger/discharger (ARBIN INSTRUMENT, BT-2000 model, USA) in the descending order of 4, 2.5, 1.25 and 0.625 A/cm².

After completion of charging, each of 20 mL of the V⁵⁺ electrolytic solution of the cathode with a state of SOC 100% containing the side reaction inhibitor was charged into 40 mL glass vial to prepare three samples.

A glass vial containing a cathodic electrolyte was placed in an oven maintained at 45° C., and the concentration (SOC change) of V⁴⁺ ions generated after 14 days was measured using a UV-vis spectrophotometer (SCINCO, S-3100 model, KR). For the reproducibility of assay and the accuracy of experiment, the concentrations of V⁴⁺ ions in the three samples were measured and the average value thereof was taken, and the state of charge (SOC) was calculated therefrom. Comparative Example 1 was prepared in the same manner as in Experimental Example 1, except that the above-described side reaction inhibitor was not added.

The results of Experimental Example 1 are shown in Table 1 below.

TABLE 1

SOC change after
SOC 100% cathodic
electrolyte left
(%, after 45 days
at 14° C.)

| [symbol] | Inhibitor | 5 mol. % | 10 mol. % |
|---|---|---|---|
| C. Ex. 1 | Not added | 95.4 | 95.4 |
| Ex. 1 | ZnSO₄ | 96.3 | 97.7 |
| Ex. 2 | K₂SO₄ | 95.7 | 96.5 |
| Ex. 3 | MgSO₄ | 95.2 | 96.1 |
| Ex. 4 | K₂HPO₄ | 95.2 | 96.3 |
| Ex. 5 | (NaPO₃)₆ | 95.6 | 96.5 |

According to the experimental results, when ZnSO₄, K₂SO₄, MgSO₄, K₂HPO₄ or (NaPO₃)₆ was used as a side reaction inhibitor, the change of SOC was observed to be lower after 14 days than that of Comparative Example 1.

### Experimental Example 2: Soc Change after Leaving a Redox Flow Battery Having SOC 100%

Experimental Example 2 was carried out in the same manner as Experimental Example 1, except that a catholyte containing 1 to 20 mol. % of ZnSO₄ was used (1.8 M VOSO₄, 2.2 M H₂SO₄, 1.8 M HCl, and 1 to 20 mol. % ZnSO₄).

After completion of charging, each of 10 mL of the V⁵⁺ electrolytic solution of the cathode with a state of SOC 100% was charged into 20 mL glass vial to prepare five samples, and then a glass vial containing an catholyte was placed in an oven maintained at 45° C., and then the concentration (SOC change) of V⁴⁺ ions generated at the interval of 1, 3, 8, 11, and 14 days was measured using a UV-vis spectrophotometer (SCINCO, S-3100 model, KR). The Comparative Example was prepared in the same manner as in Experimental Example 2, but no side reaction inhibitor (ZnSO₄) was added.

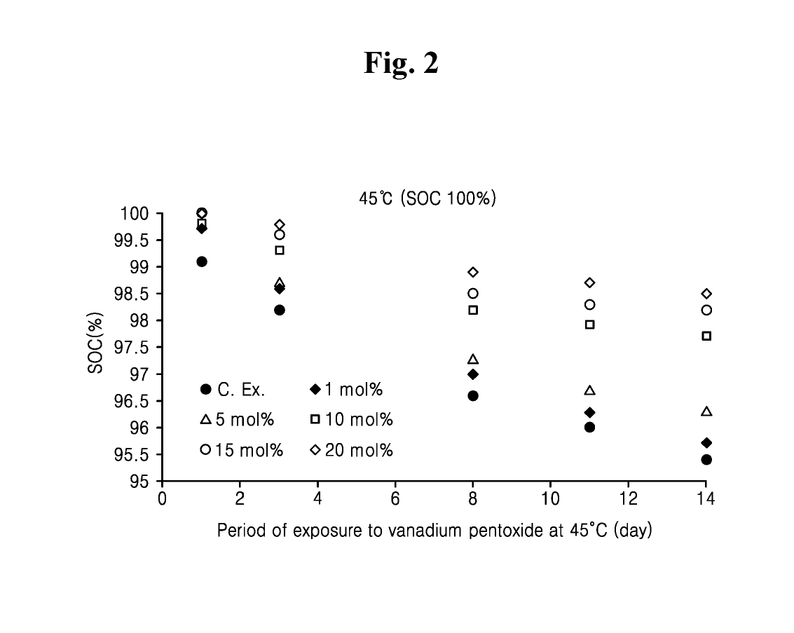

The results of Experimental Example 2 are shown in FIG. 2 attached hereto.

Referring to FIG. 2, when the external temperature was 45° C., it was observed that the SOC of the catholyte without addition of the side reaction inhibitor (ZnSO₄) dropped to 95% after 14 days from the initial state of 100%.

On the contrary, in the case of the catholyte added with the side reaction inhibitor (ZnSO₄), it was observed that the SOC reduction width was remarkably decreased in proportion to the added amount. For example, a bipolar electrolyte containing 20 mol. % of the side reaction inhibitor (ZnSO₄) exhibited a very small SOC reduction by about 1.5% after 14 days.

### Experimental Example 3: SOC Change after Leaving a Redox Flow Battery Having SOC 95%

To investigate the change of SOC in an actual charging condition (SOC≦95%), a catholyte of SOC 95% was prepared. The conditions for the preparation of a fully charged electrolyte were the same as in Experimental Example 1.

After completion of charging, a solution containing 1.58 mL of V⁴⁺ ions was added to 30 mL of a catholyte with SOC 100% containing the side reaction inhibitor (ZnSO₄) to prepare a cathodic electrolyte having an SOC of 95%.

Each of 5 mL of a vanadium electrolytic solution of the cathode with a state of SOC 95% containing the side reaction inhibitor (ZnSO₄) was charged into 20 mL glass vial to prepare samples, and then a glass vial containing an catholyte was placed in an oven maintained at 45° C., and then the concentration (SOC change) of V⁴⁺ ions generated at the interval of 1, 3, 6, 10, and 14 days was measured using a UV-vis spectrophotometer (SCINCO, S-3100 model, KR). The Comparative Example was prepared in the same manner as in Experimental Example 3, but no side reaction inhibitor (ZnSO₄) was added.

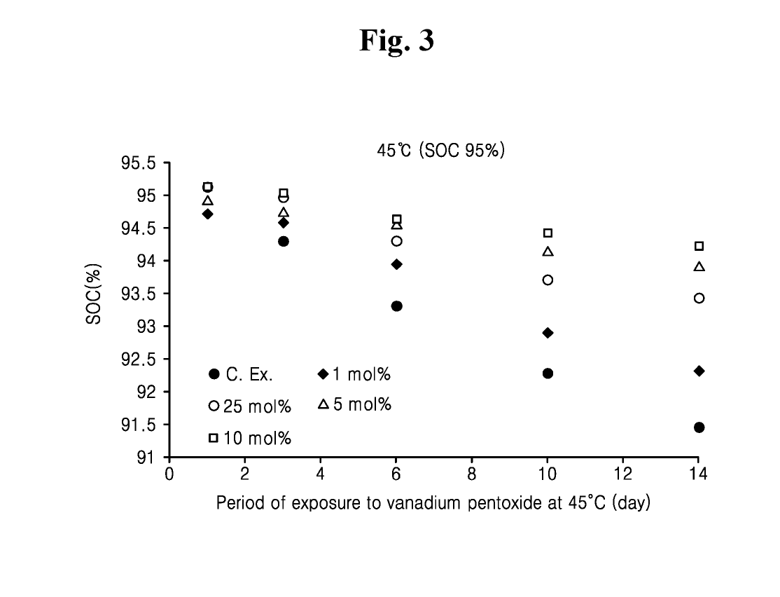

The results of Experimental Example 3 are shown in FIG. 3 attached hereto.

Referring to FIG. 3, when the external temperature was 45° C., it was observed that the SOC of the catholyte without addition of the side reaction inhibitor (ZnSO₄) dropped to 91% after 14 days from the initial state of 95%.

On the contrary, in the case of the catholyte added with the side reaction inhibitor (ZnSO₄), it was observed that the SOC reduction width was remarkably decreased in proportion to the added amount. For example, a bipolar electrolyte containing 10 mol. % of the side reaction inhibitor (ZnSO₄) exhibited a very small SOC reduction of less than about 1% after 14 days.

### Experimental Example 4: SOC Change after Leaving a Redox Flow Battery Having SOC 90%

To investigate the change of SOC in an actual charging condition (SOC≦95%), a catholyte of 90% SOC was prepared. The conditions for the preparation of a fully charged electrolyte were the same as in Experimental Example 1.

After completion of charging, a solution containing 3.33 mL of V⁴⁺ ions was added to 30 mL of a catholyte with SOC 100% containing the side reaction inhibitor (ZnSO₄) to prepare a cathodic electrolyte having an SOC of 90%.

Each of 5 mL of a catholyte with a state of SOC 90% containing the side reaction inhibitor (ZnSO₄) was charged into 20 mL glass vial to prepare samples, and then a glass vial containing an catholyte was placed in an oven maintained at 45° C., and then the concentration (SOC change) of V⁴⁺ ions generated at the interval of 1, 3, 6, 10, and 14 days was measured using a UV-vis spectrophotometer (SCINCO, S-3100 model, KR). The Comparative Example was prepared in the same manner as in Experimental Example 4, but no side reaction inhibitor (ZnSO₄) was added.

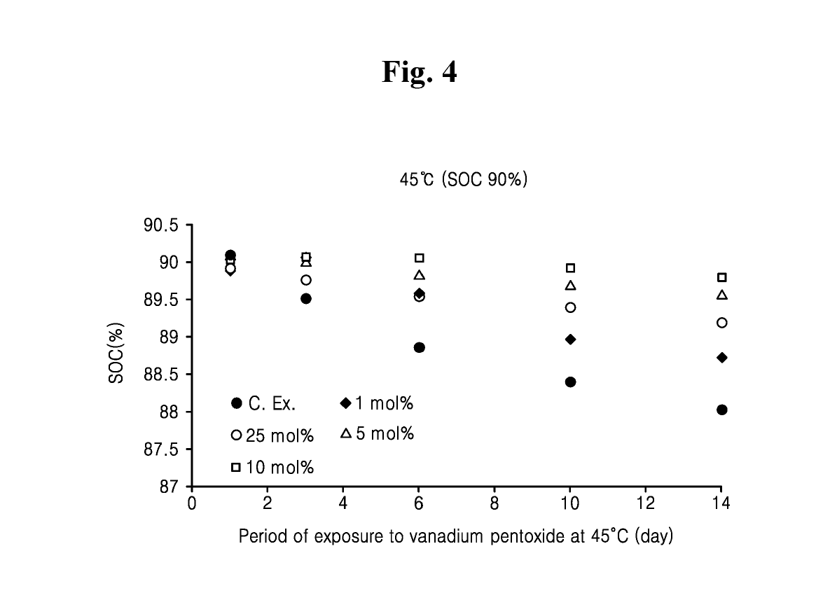

The results of Experimental Example 4 are shown in FIG. 4 attached hereto.

Referring to FIG. 4, when the external temperature was 45° C., it was observed that the SOC of the catholyte without addition of the side reaction inhibitor (ZnSO₄) dropped to 88% after 14 days from the initial state of 90%.

On the contrary, in the case of the catholyte added with the side reaction inhibitor (ZnSO₄), it was observed that the SOC reduction width was remarkably decreased in proportion to the added amount. For example, a bipolar electrolyte containing 10 mol. % of the side reaction inhibitor (ZnSO₄) exhibited a very small SOC reduction of less than about 0.5% after 14 days.

### Experimental Example 5: Pressure Change in a Container of Catholyte According to the Duration of State of Charge

A 100 mL measuring cylinder was charged with 50 mL of a vanadium tetravalent aqueous solution (1.8 M VOSO₄, 2.2 M H₂SO₄, and 1.8 M HCl) and connected to the cathode of a small single cell battery having an electrode area of 25 cm² with a cation exchange membrane (DUPONT, N115) with a VITON tube. In addition, the catholyte also contained 10 mol. % of a side reaction inhibitor (0.18 M ZnSO₄) with 100 mL of a vanadium tetravalent aqueous solution (1.8 M VOSO₄, 2.2 M H₂SO₄, and 1.8 M HCl) and was connected to a pressure sensor (all of the cathodic and anodic electrolytes may contain zinc sulfate).

A measuring cylinder containing a cell and an electrolyte was placed in an oven maintained at 45° C., and then electrolytes of the anode and the cathode was circulated by a peristaltic pump. The battery was charged at 45° C. with a current density of 4, 2.5, 1.25, and 0.625 A/cm² in the descending order thereof under 1.7 V cut-off condition using an ARBIN battery charger/discharger (ARBIN INSTRUMENT, BT-2000 model, USA) to reach to 100% of the state of charge (SOC) of the vanadium ions. After the completion of charging, the electrolytic solution in the cell was taken out of the measuring cylinder, the pumping was stopped, and the gas pressure in the electrolyte container at 45° C. was recorded with a pressure sensor for 18 hours.

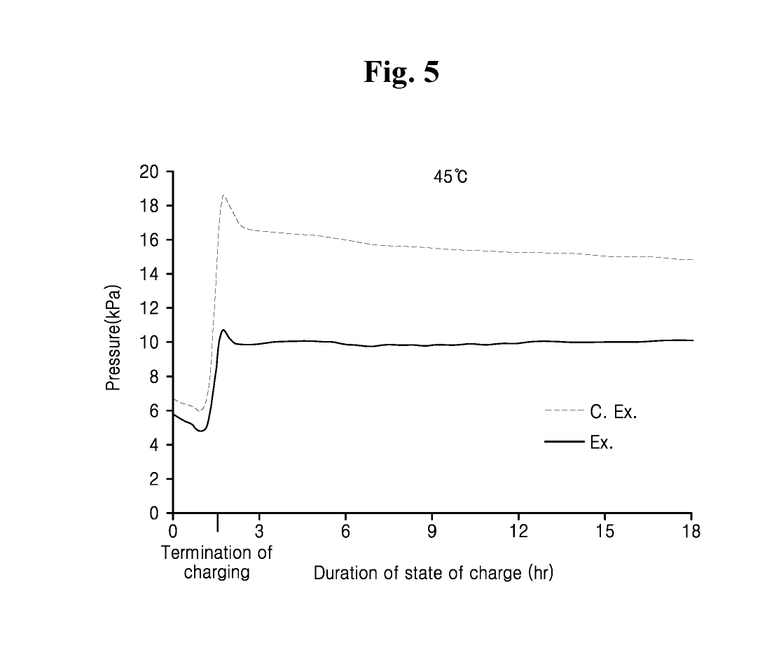

When 10 mol. % zinc sulfate was added to a 100 mL electrolyte having a void volume of 35 mL and thereby the battery was fully charged, the pressure in the equilibrium container at an external temperature of 45° C. decreased by ⅔ (15 kPa/10 kPa) compared to the case of no addition of the side reaction inhibitor (see FIG. 5).

Components contributing to the rise in gas pressure in the container can be divided into chlorine (Cl₂), water vapor and hydrochloric acid gas. The equilibrium gas pressures exhibited by aqueous vanadium tetravalent-mixed acid solutions under the same conditions were 8 kPa for the Comparative Examples (1.8 M VOSO₄, 2.2 M H₂SO₄, and 1.8 M HCl) and 5 kPa for the examples (1.8 M VOSO₄, 2.2 M H₂SO₄, and 1.8 M HCl, 10 mol. % ZnSO₄), which were resulted from water vapor and hydrochloric acid gas.

Therefore, the fact that the pressure in the equilibrium state in the presence of 10 mol. % of zinc sulfate is approximately 10 kPa indicates that the amount of chlorines (Cl₂) in the gas components of the example (10-5 kPa=5 kPa) was decreased by 5/7 compared to the amount of chlorines (Cl₂) in the Comparative Example (15-8 kPa=7 kPa).

As described above, the examples of the present disclosure disclose particularly a catholyte supplemented with ZnSO₄ as a side reaction inhibitor, but it should be understood that, in addition to ZnSO₄, the same effect can also be shown for the other side reaction inhibitors that have been proved to suppress SOC reduction from Experimental Example 1.

It will be apparent to those skilled in the art that various modifications and alterations can be made in the present disclosure without departing from the spirit and scope of the invention as defined in the appended claims, which also fall within the scope of the present disclosure.

1. A redox flow battery comprising an anolyte, a catholyte, and an ion exchange membrane, wherein the anolyte and the catholyte each comprise an electrolyte containing Cl⁻ ions and an active material containing vanadium ions, and the electrolyte comprises at least one side reaction inhibitor selected from the group consisting of metal phosphates (Mₓ(PO₄)_{y}), metal hydrochloride (MClₓ), and metal sulfates (Mₓ(SO₄)_{y}).

2. The redox flow battery of claim 1, wherein the electrolyte comprises an aqueous hydrochloric acid solution alone, or a mixture of an aqueous hydrochloric acid solution and another type of strong acid aqueous solution.

3. The redox flow battery of claim 1, wherein the electrolyte comprises a mixture of an aqueous hydrochloric acid solution and an aqueous sulfuric acid solution.

4. The redox flow battery of claim 1, wherein the metal in the side reaction inhibitor has a standard reduction potential lower than the standard reduction potential of V⁴⁺/V⁵⁺.

5. The redox flow battery of claim 4, wherein the metal in the side reaction inhibitor has a standard reduction potential lower than the standard reduction potential of V³⁺/V²⁺.

6. The redox flow battery of claim 5, wherein the metal in the side reaction inhibitor has a standard reduction potential lower than −0.25 V.

7. The redox flow battery of claim 4, wherein the metal in the side reaction inhibitor is at least one selected from the group consisting of Cd²⁺, Fe²⁺, Cr²⁺, Al²⁺, Ce²⁺, Ti²⁺, Zn²⁺, Mn²⁺, Mg²⁺, Na⁺, Ca²⁺, Ba²⁺, K⁺ and Li⁺.

8. The redox flow battery of claim 1, wherein the side reaction inhibitor is at least one selected from the group consisting of ZnSO₄, K₂SO₄, MgSO₄, K₂HPO₄ and (NaPO₃)₆.

9. The redox flow battery of claim 1, wherein the side reaction inhibitor is comprised in the electrolyte in an amount of 0.1 mol. % to 50 mol. % based on the vanadium ions.

10. The redox flow battery of claim 1, wherein the side reaction inhibitor suppresses the oxidation and reduction reactions of V⁵⁺ ions and Cl⁻ ions in the catholyte.

11. The redox flow battery of claim 10, wherein the side reaction inhibitor suppresses a decrease in the state of charge of the redox flow battery when the redox flow battery is left at a temperature of 40° C. or higher.

12. The redox flow battery of claim 10, wherein the side reaction inhibitor suppresses the oxidation reaction of Cl⁻ ions to Cl₂ in the anolyte and the catholyte, while a voltage of 1.25 V or more is applied to the electrolyte.
